(19) United States
(12) Patent Application Publication
(10) Pub. No.: US 2012/0216123 A1
(43) Pub. Date: Aug. 23, 2012

(54) ENERGY AUDIT SYSTEMS AND METHODS

(75) Inventors: Leo Shklovskii, Seattle, WA (US); Aaron Goldfeder, Seattle, WA (US); Scott Case, Seattle, WA (US); Michael Blasnik, Boston, MA (US)

(73) Assignee: EVOWORX INC., Seattle, WA (US)

(21) Appl. No.: 13/403,844

(22) Filed: Feb. 23, 2012

Related U.S. Application Data
(60) Provisional application No. 61/446,025, filed on Feb. 23, 2011.
(60) Provisional application No. 61/446,028, filed on Feb. 23, 2011.

(51) Int. Cl. G06F 3/048; G06G 7/48; G06F 15/16

(52) U.S. Cl. 715/738; 703/6

(57) ABSTRACT

An online energy audit system poses and collects responses to a list of survey questions regarding a subject house from a remote occupant via a survey UI. Survey responses are stored in an energy-use profile associated with the subject house and are used to populate model inputs to an energy-use software model, from which an energy-efficiency score is derived. To help a remote occupant choose appropriate answers and to facilitate completion of the survey, the survey UI includes question-specific house-feature images associated with some or all questions. Survey questions are designed to be easy for a homeowner to understand, and the survey is kept short. The energy-efficiency score of the subject house is presented to the remote occupant in comparison with comparison energy-use data together with an action message to encourage the remote occupant to improve the energy score of the subject house.

### CROSS REFERENCE TO RELATED APPLICATIONS

This application claims the benefit of priority to U.S. Provisional Application No. 61/446,025, filed Feb. 23, 2011, titled “ADAPTIVE VISUAL HOME ENERGY PROFILE METHOD AND SYSTEM,” filed under Attorney Docket No. EVOW-2011002, and naming the following inventors: Leo Shklovskii, Aaron Goldfeder, Scott Case, and Michael Blasnik. This application also claims the benefit of priority to U.S. Provisional Application No. 61/446,028, filed Feb. 23, 2011, titled “HOME ENERGY PROFILE MODIFICATION BASED ON MULTI-VARIABLE ENERGY EFFICIENCY RECOMMENDATIONS AND SOCIALLY RELATIVE COMPARISONS METHOD AND SYSTEM,” filed under Attorney Docket No. EVOW-2011003, and naming the following inventors: Leo Shklovskii, Aaron Goldfeder, Scott Case, and Michael Blasnik. The above-cited applications are incorporated herein by reference in their entireties, for all purposes.

### FIELD

The present disclosure relates to the field of energy auditing, and more particularly, to providing an online energy audit service to encourage energy efficiency improvements.

### BACKGROUND

Home energy audits are typically designed to identify energy inefficiencies in homes. Based on the result of an energy audit, certain energy efficiency improvements may be made. Traditionally, energy audits are performed by a professional auditor who visits and physically examines a home. While in-home energy audits are likely to yield accurate measurements of the energy use of a home, they also tend to be costly. In addition, the recommendations made by an in-home auditor may be perceived as biased due to the auditor's affiliations.

Online energy audits provide a cheaper and more convenient alternative to in-home audits. For example, online energy audits may be completed for free by a homeowner at his or her leisure without involving a professional auditor. In addition, recommendations made by an online energy audit may be perceived as unbiased because the person conducting the audit is the homeowner.

However, existing online energy audit tools have failed to lead to significant energy efficiency improvements. One contributing factor to this failure may be a low completion rate of online energy audits due to both the complexity and length of the questions presented in the audits. Another contributing factor may be the lack of adequate incentives to adopt energy efficiency improvements upon the completion of an audit.

### BRIEF DESCRIPTION OF THE DRAWINGS

FIG. 1 illustrates an exemplary online energy audit system, in accordance with one embodiment.

FIG. 2 illustrates several components of an exemplary energy audit server, in accordance with one embodiment.

FIG. 3 illustrates an energy-use profile generation routine, in accordance with one embodiment.

FIG. 4 illustrates a subroutine for providing a survey user interface (“UI”) and collecting survey responses, in accordance with one embodiment.

FIG. 5 illustrates an energy-efficiency display routine, in accordance with one embodiment.

FIG. 6 illustrates a subroutine for obtaining an energy-efficiency score for a subject house, in accordance with one embodiment.

FIG. 7 illustrates a subroutine for obtaining comparison energy-use data, in accordance with one embodiment.

FIG. 8 illustrates a subroutine for obtaining comparison energy-use data, in accordance with one embodiment.

FIG. 9 illustrates exemplary model inputs and their respective input values, in accordance with one embodiment.

FIG. 10 illustrates a survey UI showing survey questions non-image-based answer options, in accordance with one embodiment.

FIGS. 11a-c illustrate an exemplary survey UI showing conditional survey-question presentation, in accordance with one embodiment.

FIG. 12 illustrates a survey UI showing a survey question with several simultaneously displayed image-based answer options, in accordance with one embodiment.

FIGS. 13a-b illustrate a survey UI showing a survey question with individually displayed image-based answer options, in accordance with another embodiment.

FIG. 14 illustrates an exemplary comparison UI, as may be seen by a remote occupant, in accordance with one embodiment.

FIG. 15 illustrates exemplary house characteristics grouped by topic, in accordance with one embodiment.

### DESCRIPTION

In according with various embodiments, an online energy audit system and method is provided to pose and collect responses to a list of survey questions regarding a subject house via a survey UI from a remote occupant. The survey responses are stored in a subject-home energy-use profile associated with the subject house and are used to populate model inputs to an energy-use software model, from which an energy-efficiency score is derived. To help a remote occupant choose the appropriate answers and facilitate the completion of the survey, the survey UI includes question-specific house-feature images associated with each question. In addition, the survey questions are designed to be simple and easy-to-understand, and the survey is kept as short as practicable. An energy-efficiency score of the subject house is presented to the remote occupant in comparison with energy-use data for similar houses, together with an action message to encourage the remote occupant to improve the energy score of the subject house.

As used herein, the terms “survey” and “audit” are used interchangeably. Similarly, the terms “energy consumer,” “remote occupant,” and “homeowner” are used interchangeably to refer to the person who uses the online energy auditing service to assess the energy efficiency of a subject house.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

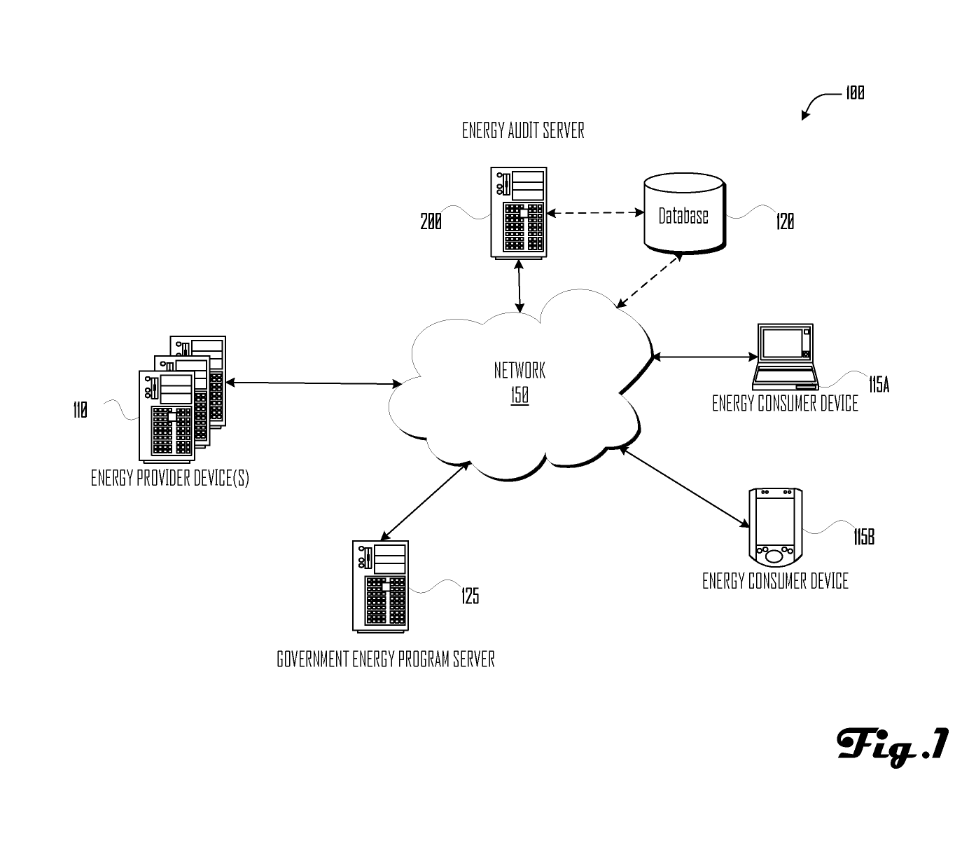

FIG. 1 illustrates an exemplary online energy audit system 100, in accordance with one embodiment, in which energy audit server 200, energy provider device(s) 110, energy consumer devices 115A-B, and government energy program server 125 are connected to network 150. Processing server 200 is also in communication with database 120. In some embodiments, processing server 200 may communicate with database 120 via network 150, a storage area network (“SAN”), a high-speed serial bus, and/or via other suitable communication technology.

In various embodiments, energy audit server 200 and/or database 120 may comprise one or more physical and/or logical devices that collectively provide the functionalities described herein. In some embodiments, energy audit server 200 and/or database 120 may comprise one or more replicated and/or distributed physical or logical devices. In some embodiments, energy audit server 200 may comprise one or more computing services provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like. In some embodiments, database 120 may comprise one or more storage services provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

In various embodiments, network 150 may include the Internet, a local area network (“LAN”), a wide area network (“WAN”), a cellular data network, and/or other data network.

In various embodiments, energy provider device(s) 110 are operated by a provider of gas, electricity, oil, renewable energy, or the like. Examples of an energy provider include FirstEnergy Corporation of Akron, Ohio; Chesapeake Energy of Oklahoma City, Okla.; Exxon Mobile Corporation of Irving, Tex., and the like. In various embodiments, an energy provider device 110 may provide energy-usage data including cost of energy, energy consumed by certain households, statistical data, and the like. In some embodiments, an energy provider device 110 may also provide information about services provided, energy incentives programs (e.g., rebates), and the like.

In various embodiments, energy consumer device(s) 115 may include a desktop PC, laptop 115A, mobile phone 115B, tablet, or other computing device. In various embodiments, an energy consumer device 115 is connected to network 150 and includes a web browser.

In various embodiments, a government energy program server 125 is operated by a government agency such as Department of Energy, a state, or the like. In various embodiments, government energy program server 125 may provide information and/or statistics related to energy-usage, energy incentives programs (e.g., tax rebates and credits), and the like.

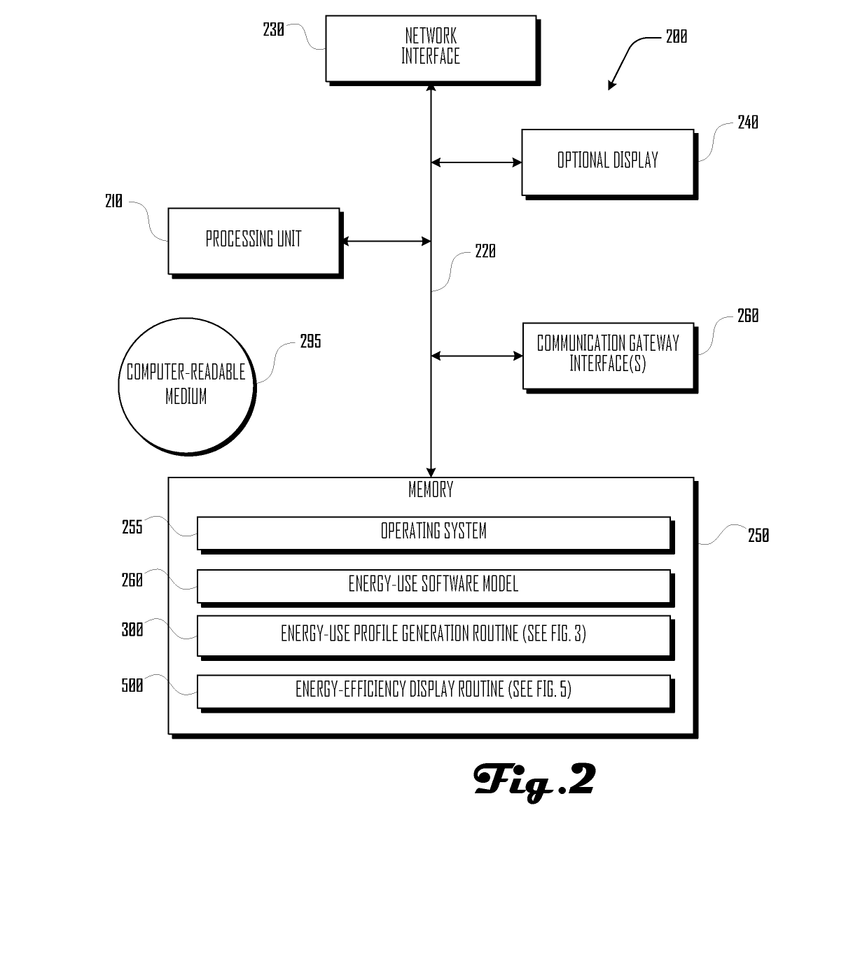

FIG. 2 illustrates several components of an exemplary energy audit server 200, in accordance with one embodiment. In some embodiments, processing server 200 may include many more components than those shown in FIG. 2. However, it is not necessary that all of these generally conventional components be shown in order to disclose an illustrative embodiment.

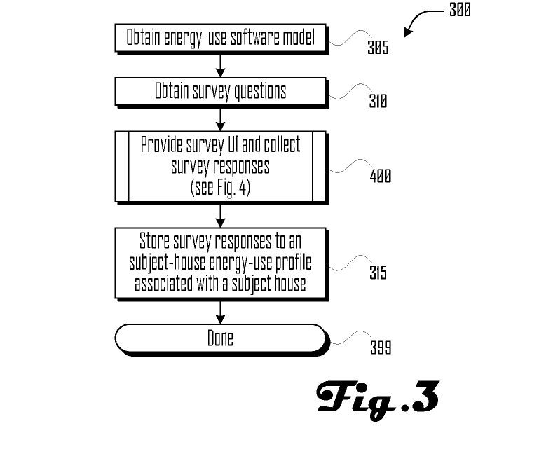

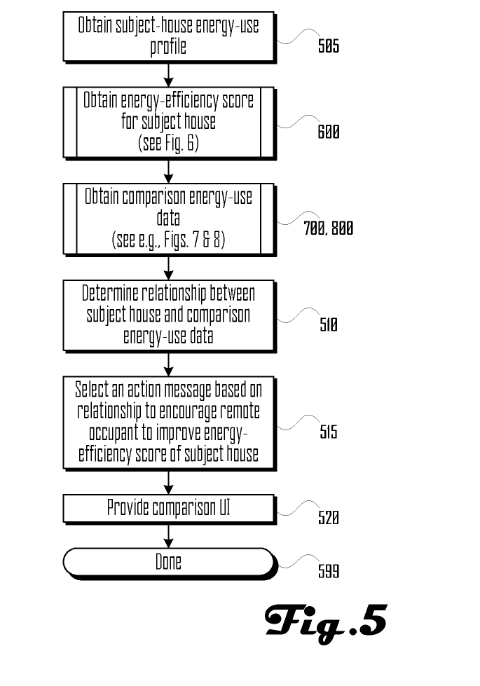

As shown in FIG. 2, processing server 200 includes a network interface 230 for connecting to network 150. Processing server 200 also includes a processing unit 210, a memory 250, and an optional display 240, all interconnected along with the network interface 230 via a bus 220. Memory 250 generally comprises a random access memory (“RAM”), a read only memory (“ROM”), and a permanent mass storage device, such as a disk drive. Memory 250 stores the program code for an energy-use software model 260 (discussed below), an energy-use profile generation routine 300 (see FIG. 3, discussed below), and an energy-efficiency display routine 500 (see FIG. 5, discussed below). In addition, memory 250 also stores an operating system 255. These software components may be loaded into memory 250 of processing server 200 using a drive mechanism (not shown) associated with a non-transient computer readable storage medium 295, such as a floppy disc, tape, DVD/CD-ROM drive, memory card, or the like. In some embodiments, software components may alternately be loaded via the network interface 230, rather than via a non-transient computer readable storage medium 295.

Processing server 200 also communicates via bus 220 with database 120 (see FIG. 1). In various embodiments, bus 220 may comprise a storage area network (“SAN”), a high-speed serial bus, and/or via other suitable communication technology. In some embodiments, processing server 200 may communicate with database 120 via network interface 230.

FIG. 3 illustrates an energy-use profile generation routine 300, such as may be performed by energy audit server 200, in accordance with one embodiment.

In block 305, routine 300 obtains an energy-use software model 260. As used herein, the term “energy-use software model” refers to a computer software program that is capable of simulating or predicting the energy use of a building based on a set of model inputs. Examples of an energy-use software model include the SIMPLE Model, provided by M. Blasnik and Associates of Boston, Mass. In various embodiments, model inputs correspond to one or more “house characteristics.” As used herein, the term “house characteristic” refers to information about a house that is relevant to determining the energy use of the house.

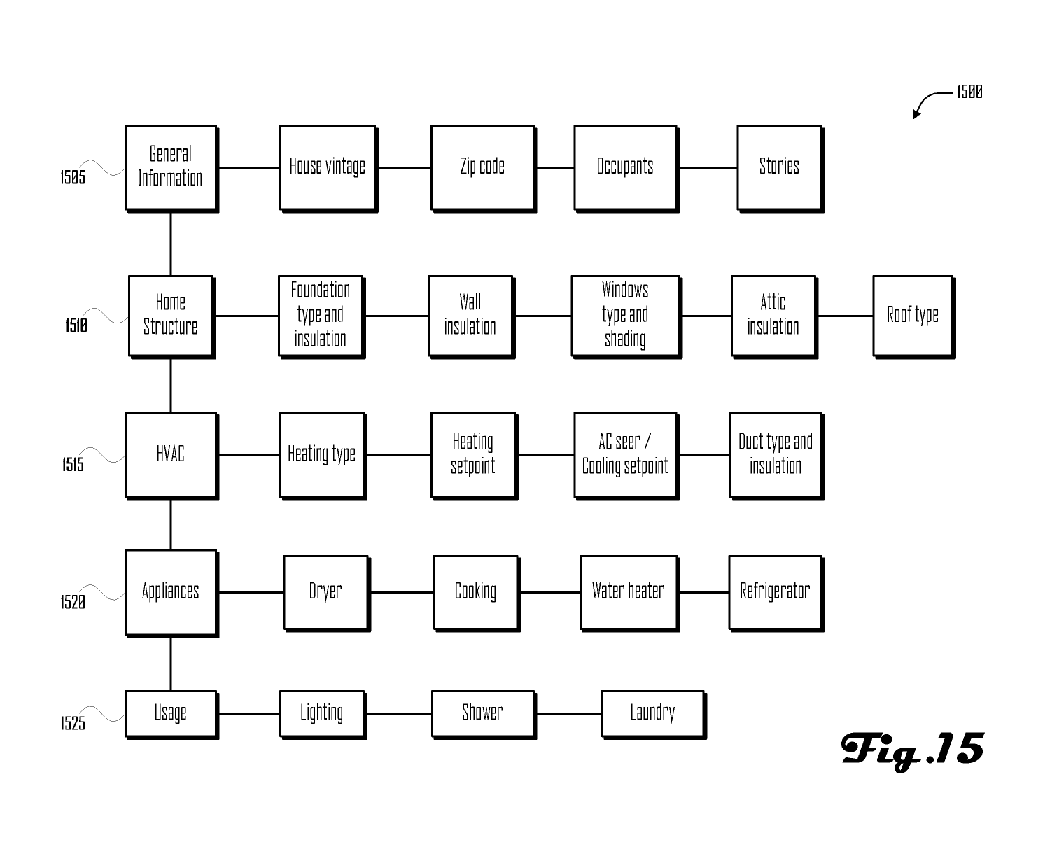

For example, FIG. 15 illustrates exemplary house characteristics grouped by topic, in accordance with one embodiment. For example, house characteristics may include general information 1505 about the house (e.g., house vintage, zip code, number of occupants, number of stories, and the like), structural information 1510 (e.g., foundation type, wall insulation, attic insulation, and the like), information 1515 relating to heating, ventilation and air conditioning (“HVAC”), appliance-related information 1520 (e.g., dryer, refrigerator, and the like), and usage-related information 1525 (e.g., lighting, shower, and the like).

Referring again to FIG. 3, in block 310, routine 300 obtains one or more survey questions that are related to house characteristics, such as those described above. In various embodiments, survey questions are used to solicit survey responses which may be used to generate model inputs for an energy use software model (e.g., item 260 of FIG. 2). In various embodiments, each survey question may be associated with one or more predetermined answer options.

In some embodiments, a survey question may be associated with a relatively small number of predetermined answer options. For example, a survey question asking about the foundation type of a house may be associated with three answer options, such as “Slab,” “Basement,” and “Crawl space.” In such embodiments, a remote occupant may select one of the answer options in response to the survey question. In other embodiments, a survey question may be associated with many answer options. In some embodiments, a remote occupant may be required to enter an alphanumeric response (e.g., zip code, year, or the like). Typically, such a survey response may be restricted by one or more constraints associated with the survey question. For example, a survey question asking for the zip code of a house may have the constraint that the response must be a valid zip code in the U.S.

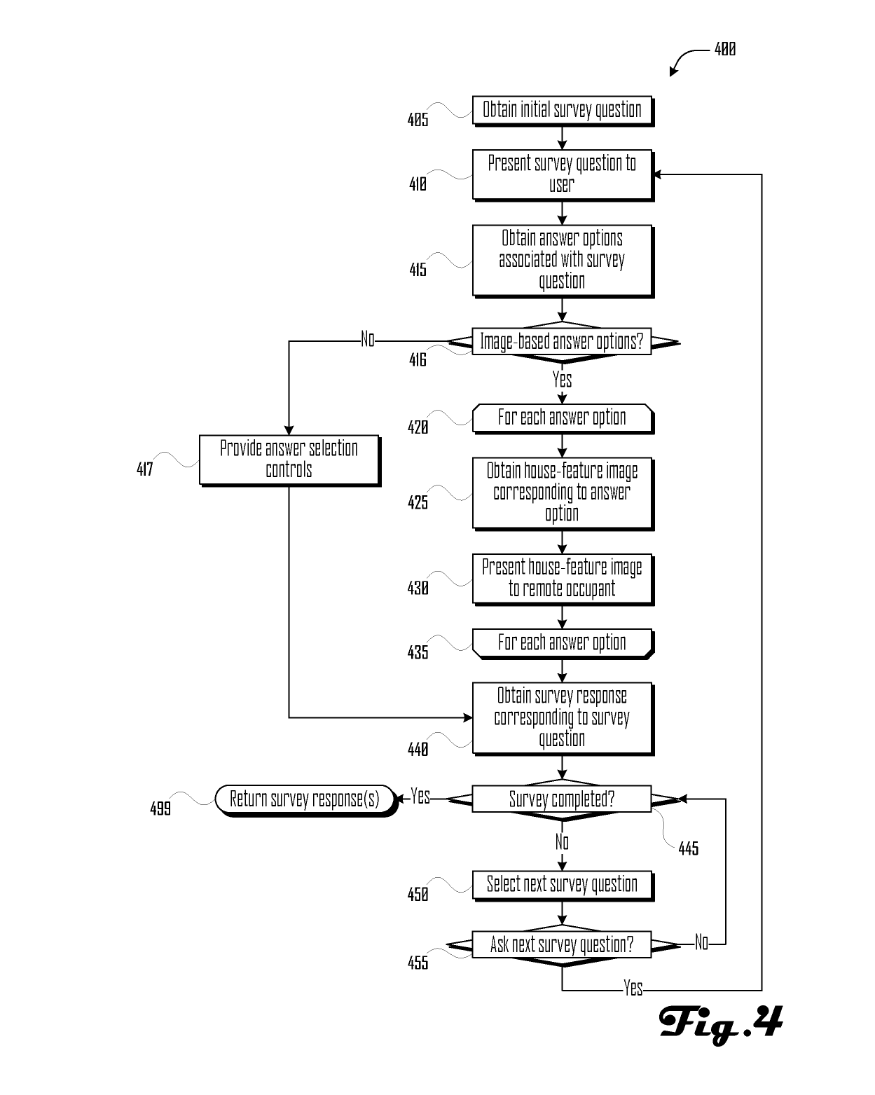

In subroutine block 400, routine 300 uses subroutine 400 (see FIG. 4, discussed below) to provide a survey UI with survey questions and collect the remote occupant's survey responses regarding a particular subject house. For example, the survey UI may be provided to energy consumer device 115 to be rendered in a web browser. In various embodiments, survey UI may be presented to reduce the quantity of survey responses that need to be collected and/or to facilitate the completion of the audit by a remote occupant. For example, the questions and answer options presented may be designed to be easily understood by a lay homeowner who has little knowledge about energy auditing. For another example, the questions and answer options may be presented in a fun and engaging way. For yet another example, as discussed further below, some questions may be skipped based on the remote occupant's response(s) to previous question(s).

In block 315, routine 300 stores (e.g., in database 120) survey responses, such as those collected above, in a subject-house energy-use profile associated with a subject house. Routine 300 ends in 399.

FIG. 4 illustrates a subroutine for providing a survey UI and collecting survey responses, in accordance with one embodiment. In block 405, subroutine 400 obtains (e.g., from database 120) an initial survey question to present to a remote occupant regarding a subject house.

In block 410, subroutine 400 presents the survey question to the remote occupant in a survey UI. In various embodiments, subroutine 400 provides client-side instructions (e.g., Hypertext Markup Language, JavaScript, and the like) necessary for presenting survey questions and for collecting survey responses in a web browser on energy consumer device 115.

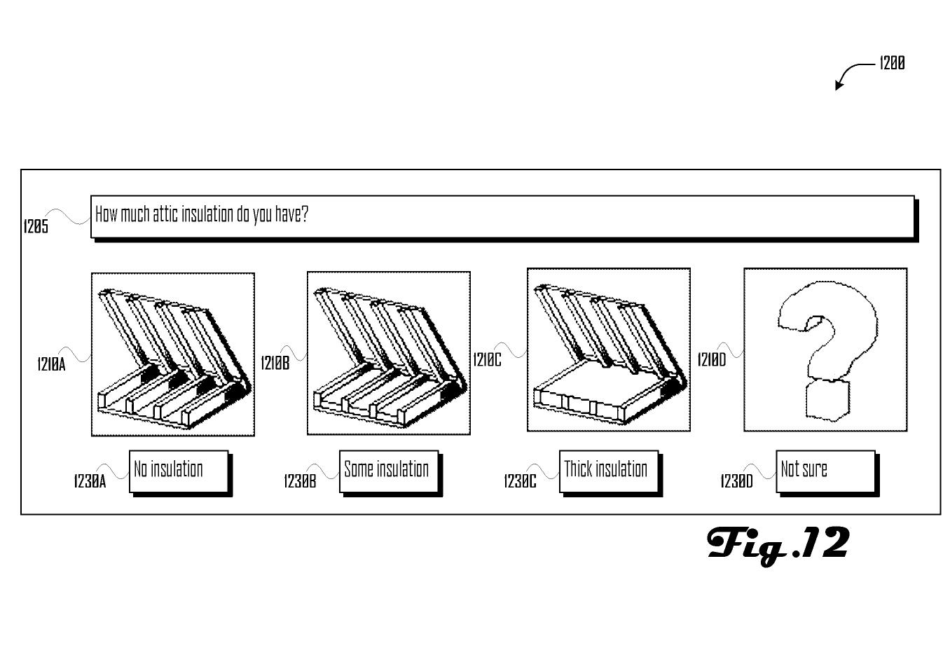

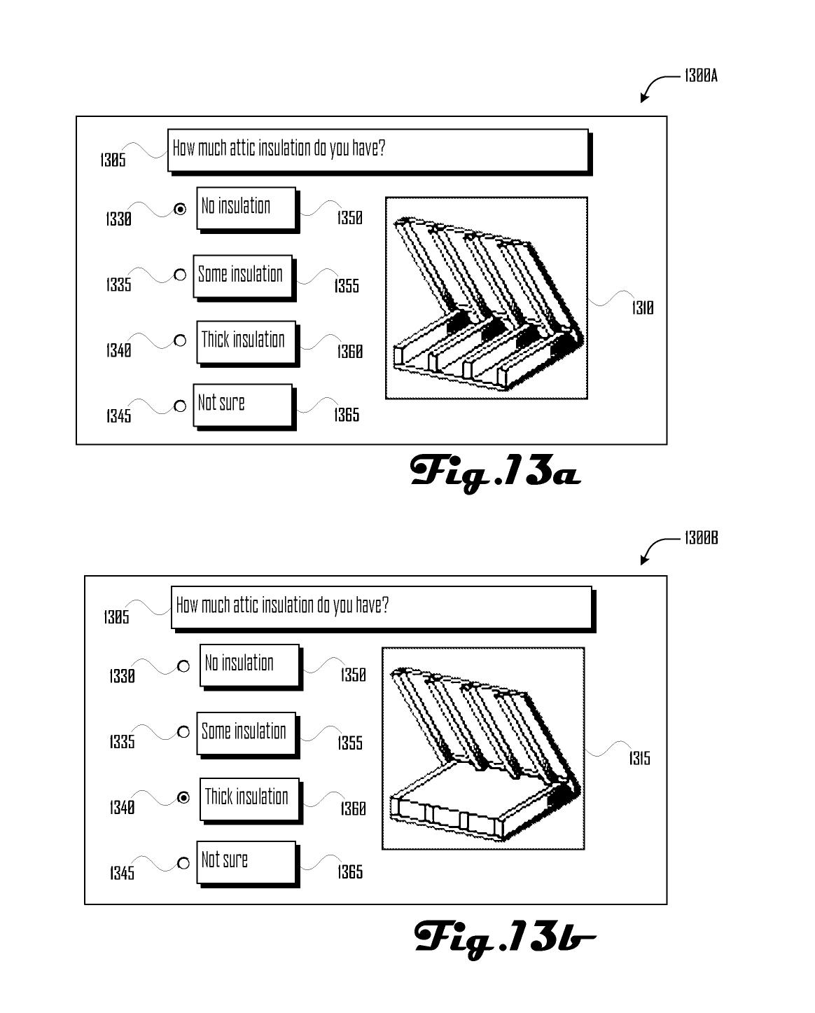

In block 415, subroutine 400 obtains answer options associated with the survey question. In decision block 416, subroutine 400 determines whether there are any question-specific house-feature images associated with the answer options. In various embodiments, an answer option may be associated with one or more question-specific house-feature images, where each house-feature image depicts a representative house feature corresponding to a predetermined answer option. Such house-feature images are typically provided to help a remote occupant select an appropriate answer option for the current question. For example, a house-feature image may depict a house feature in an easy-to-understand and/or interesting way (see FIGS. 12-13, discussed below).

If there are one or more image-based answer options associated with the current survey question, then beginning in opening loop block 420, subroutine 400 processes each answer option associated with the current survey question in turn. In block 425, subroutine 400 obtains an image corresponding to the answer option. In block 430, subroutine 400 presents the house-feature image to a remote occupant in the survey UI. In closing loop block 435, routine 400 iterates back to opening loop block 420 to process the next answer option associated with the current survey question, if any.

Otherwise, if there is no image-based answer option associated with the current question, then in block 417, subroutine 400 provides answer-option selection controls to the remote occupant via the survey UI. In some embodiments, subroutine 400 may provide answer option selection controls that do not require alphanumeric data entry (e.g., links, buttons, check boxes, dropdown lists, and the like). For example, subroutine 400 may provide a map control that a remote occupant may click on to select a zip code or other location-related data for a subject house. For another example, subroutine 400 may provide a thermostat control for a remote occupant to select a heating set point for a subject house.

In other embodiments, where there are many answer options associated with a question (e.g., zip code, year built, and the like), subroutine 400 may provide answer option selection controls that require alphanumeric data entry (e.g., text boxes) for a remote occupant to enter an alphanumeric response (e.g., using a keyboard).

In some embodiments, the survey UI may present no answer option selection controls that require alphanumeric data entry. In such embodiments, a remote occupant taking the survey does not need to type anything to respond to the survey questions. In other embodiments, survey UI may, for some questions, provide alphanumeric data entry controls for a remote occupant to enter an alphanumeric response via a keyboard.

In block 440, subroutine 400 obtains a survey response corresponding to the current survey question. In some embodiments, subroutine 400 may check the validity of a survey response. For example, subroutine 400 may check that a valid U.S. zip code is entered as a response to a survey question asking for the zip code of a house. In other embodiments, subroutine 400 may provide a default survey response if a remote occupant does not enter a survey response.

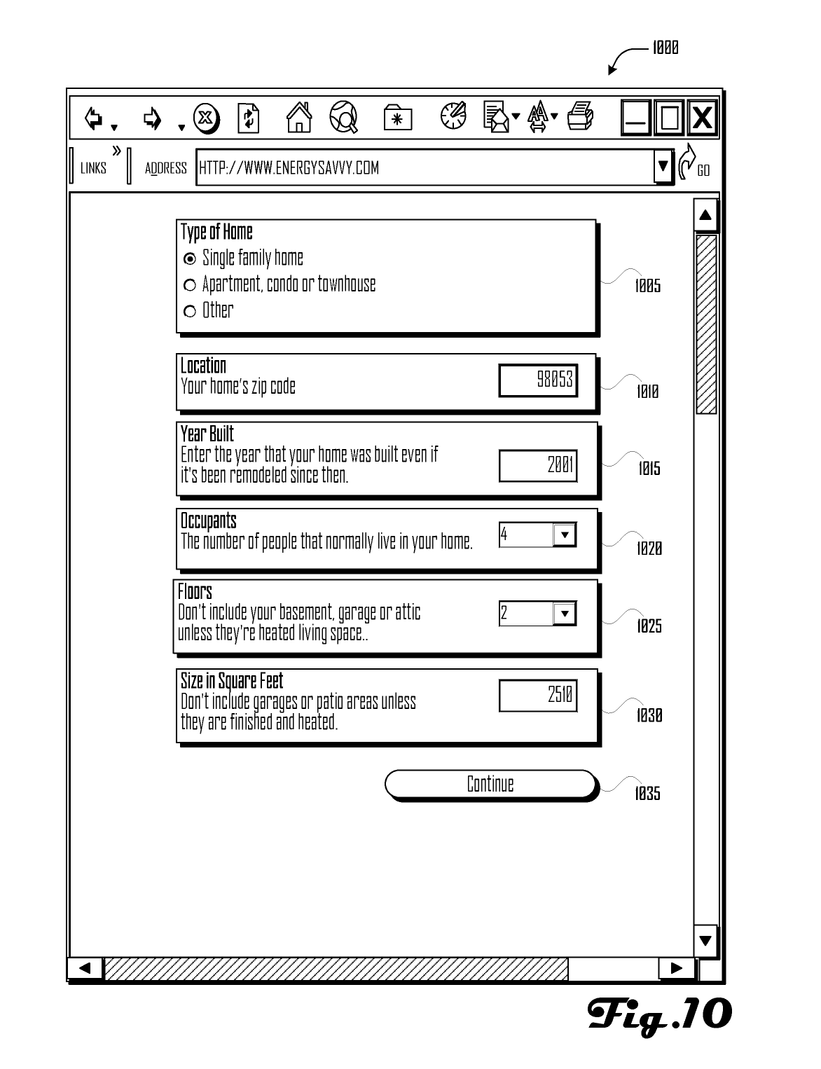

FIGS. 10 and 12-13 illustrate exemplary survey UIs showing survey questions and answer options, in accordance with various embodiments.

FIG. 10 illustrates a survey UI showing survey questions with no image-based answer options, in accordance with one embodiment. In the illustrated embodiment, a remote occupant may indicate the type of home 1005 by selecting a radio button associated with the proper answer option; entering the zip code 1010, year built 1015, and square footage 1030 of a home in an alphanumeric data entry control (e.g., a text box); and selecting the number of occupants and the number of stories from a dropdown list associated with the respective survey questions. The survey UI may optionally include navigational controls, such as a “Continue” button 1035, to help a remote occupant navigate back and forth between sets of questions.

FIG. 12 illustrates a survey UI showing a survey question with several simultaneously displayed image-based answer options 1210A-D, in accordance with one embodiment. For the illustrated survey question 1205, the survey UI simultaneously displays each of the four image-based answer options 1210A-D associated with the survey question. In addition, the survey UI may optionally include other descriptive data, such as labels 1230A-D for the respective image-based answer options. In this embodiment, a remote occupant may select an answer option by clicking on the image associated with an answer option. In another embodiments, a remote occupant may select an answer option by clicking on a radio button (not shown) associated with the image-based answer option.

FIGS. 13a-b illustrate a survey UI showing a survey question with individually displayed image-based answer options, in accordance with one embodiment. In the illustrated embodiment, the image displayed is changed dynamically to correspond to the selected answer option. For example, when answer option “No insulation” 1330 is selected (as shown in FIG. 13a), an image 1310 of an attic with no insulation is displayed. On the other hand, when answer option “Thick insulation” 1340 is selected (as shown in FIG. 13b), an image 1315 of an attic with thick insulation is displayed instead. In various embodiments, image-based answer options are provided to facilitate a remote occupant selecting an appropriate answer option for the current question.

Referring again to FIG. 4, in decision block 445, subroutine 400 determines whether the survey is completed. In various embodiments, a survey is completed when there are no more survey questions to present to the remote occupant. In some embodiments, a survey is completed when a predetermined or dynamically determined subset of the survey questions have been answered. In other embodiments, a survey is completed when all of the questions presented been answered.

If the survey is determined to be completed, then subroutine 400 returns collected survey response(s) in ending block 499. Otherwise, if survey is not yet completed, then in block 450 subroutine 400 selects the next question to present to the remote occupant. In some embodiments, subroutine 400 may select the next question based on at least one prior survey response. For example, subroutine 400 may select different questions about the heating system depending on the remote occupant's response about the type of energy (e.g., gas, electric, or oil) used by the heating system. In other embodiments, subroutine 400 may select the next question based on a predetermined order.

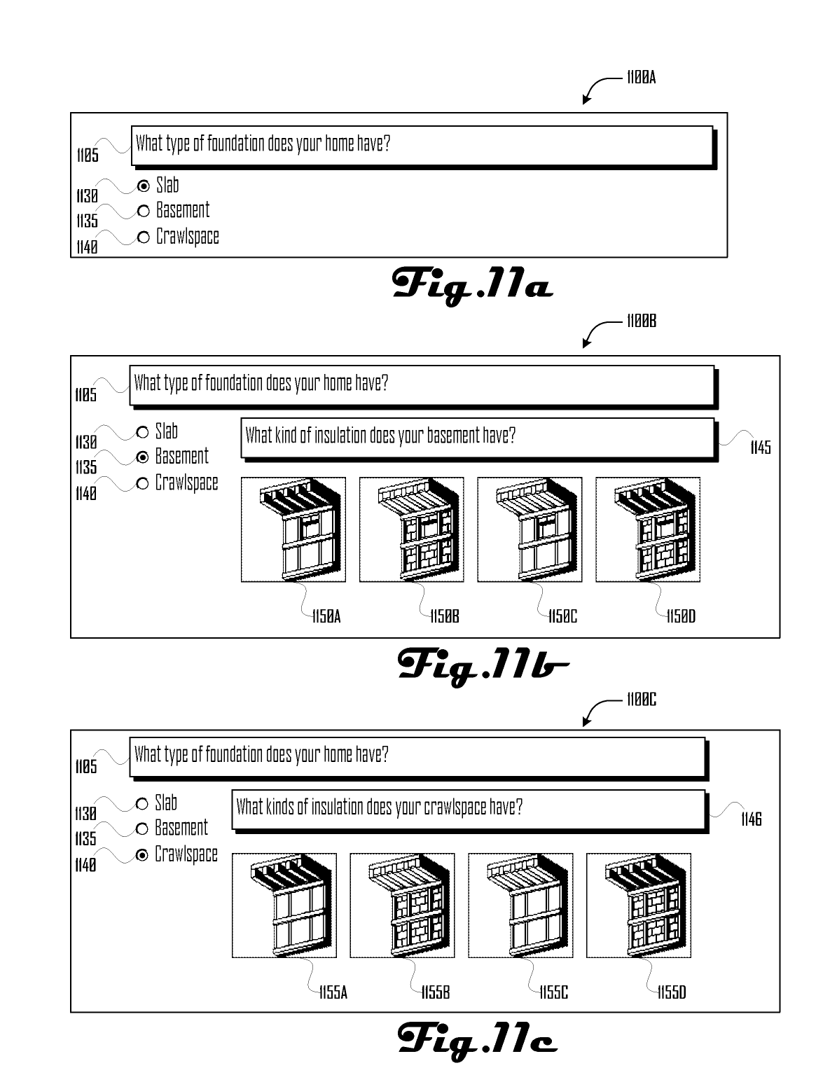

FIGS. 11a-c illustrate an exemplary survey UI that presents survey questions based on the response to a previous question, in accordance with one embodiment. For the illustrated survey question 1105 regarding the type of foundation of a house, if the remote occupant selects answer option “Slab” 1130, then no further question is displayed, as shown in FIG. 11a. Otherwise, if the remote occupant selects answer option “Basement” 1135, then a further question 1145 about the insulation of the basement is displayed including answer options 1150A-D associated with question 1145, as shown in FIG. 11b. Finally, if the remote occupant selects answer option “Crawl space” 1135, then question 1146 about the insulation of the crawl space is displayed, including answer options 1155A-D associated with question 1146, as shown in FIG. 11c.

Referring again to FIG. 4, in decision block 455, subroutine 400 determines whether to ask the survey question selected in block 450. In various embodiments, subroutine 400 may determine not to ask a question, based at least in part on previously obtained survey responses in order to reduce the quantity of survey responses that need to be collected to populate the model inputs of an energy-use software model (discussed below).

For example, subroutine 400 may determine not to ask a question about the type of wall insulation if the house vintage indicates that the house was built after 1980, but to assume that the wall insulation is of a standard type. For another example, subroutine 400 may determine not to ask a question about roof type (e.g., reflective or standard) if the zip code provided by the remote occupant indicates that the house is located in a cool climate. For yet another example, subroutine 400 may determine not to ask a question related to air ducts in basement or crawl space (e.g., percentage of air ducts in attic) if the remote occupant indicates that the house does not have a basement or crawl space.

If in decision block 455, subroutine 400 determines to ask the question selected in block 450, then subroutine 400 loops back to block 410 to present the survey question to the remote occupant. Otherwise, if subroutine 400 determines not to ask the present question, then subroutine 400 loops back to decision block 445 to determine whether the survey is completed. If the survey is completed, as described above, subroutine 400 returns collected survey responses in ending block 499. Otherwise, subroutine 400 selects the next question in block 450, as described above.

FIG. 5 illustrates an energy-efficiency display routine 500, in accordance with one embodiment. In block 505, routine 500 obtains a subject-house energy-use profile (e.g., from database 120) associated with a subject house. As described above, a subject-house energy-use profile includes stored survey responses associated with a subject house.

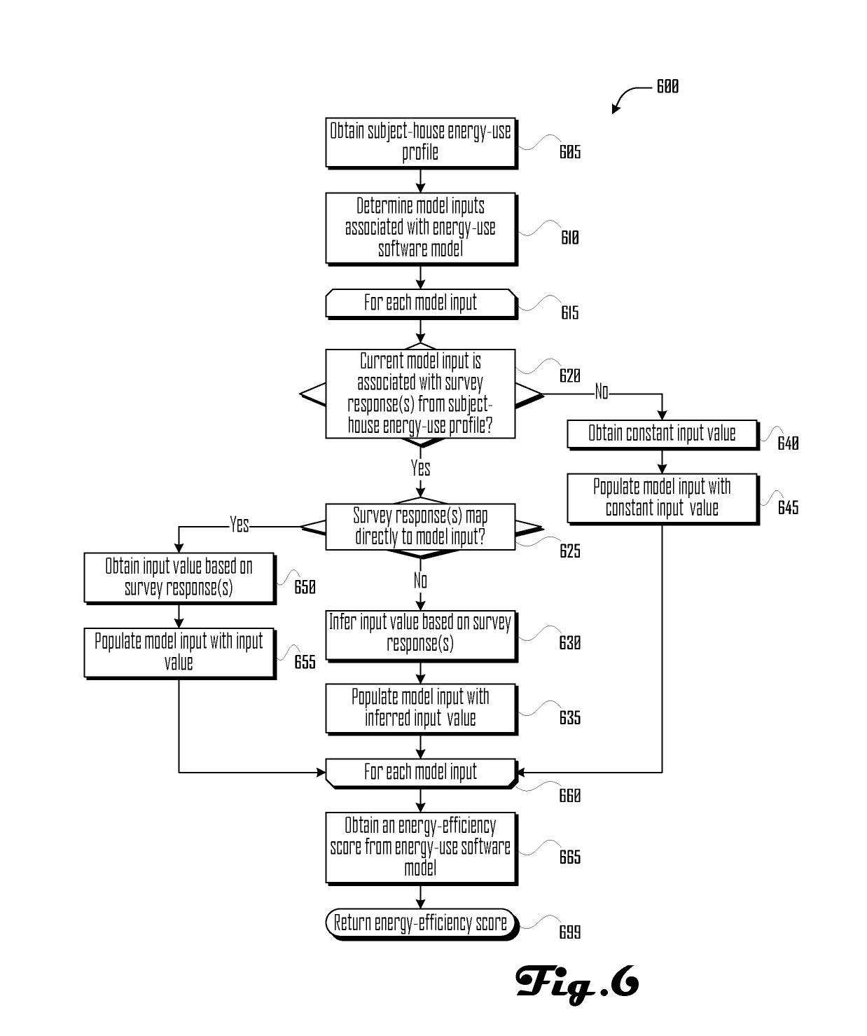

In subroutine block 600, routine 500 uses subroutine 600 (see FIG. 6, discussed below) to obtain an “energy-efficiency score” of the subject house based on the subject-house energy-use profile associated with the subject house. As used herein, the term “energy-efficiency score” refers to a numeric indication of the energy efficiency of a building. In some embodiments, the higher the energy-efficiency score is the more energy efficient a house is. For example, an energy-efficiency score of 100 may be associated with a highly energy efficient house while an energy-efficiency score of 0 may be associated with the a highly inefficient house.

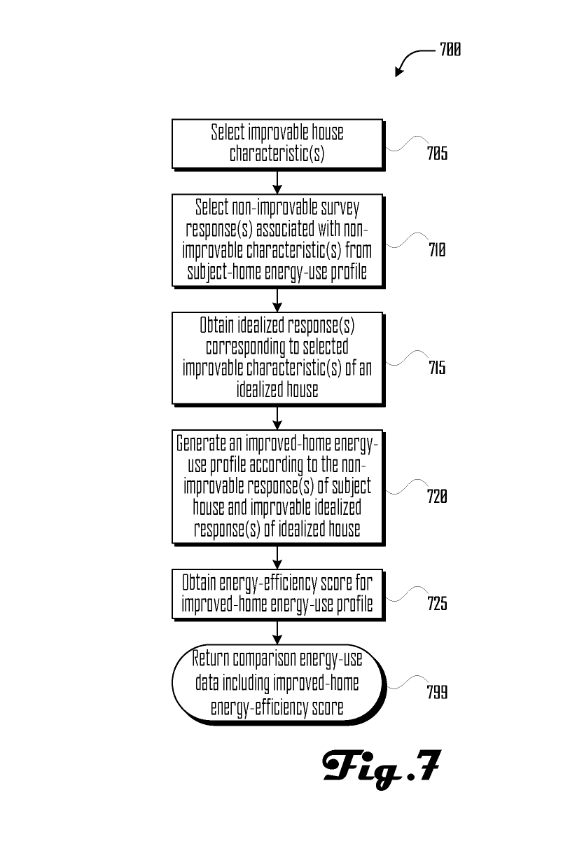

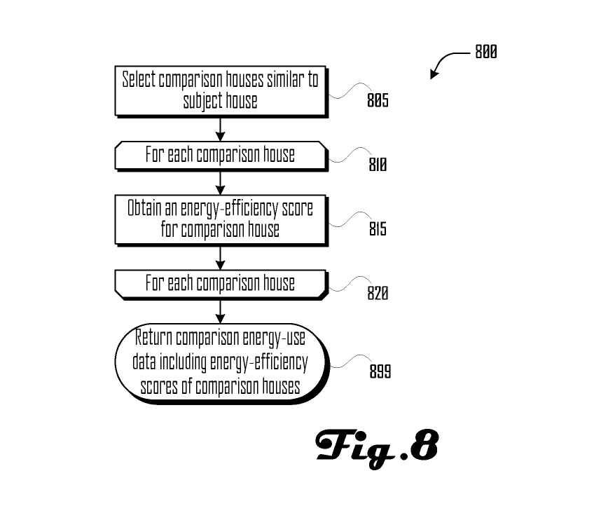

In subroutine block 700/800, routine 500 uses a subroutine such as subroutine 700 (see FIG. 7, discussed below), 800 (see FIG. 8, discussed below), or the like, to obtain “comparison energy-use data.” In various embodiments, comparison energy-use data may include the energy-efficiency score of an actual or hypothetical comparison house, energy-efficiency scores of a collection of comparison houses similar to the subject house, and the like.

In block 510, routine 500 determines a relationship between the subject house and the comparison energy-use data. In various embodiments, the relationship may include a mathematical relationship (e.g., greater than, less than, and the like) between the energy-efficiency score of the subject house and the energy-efficiency score of a comparison house, a ranking of the energy-efficiency scores of the subject house and the comparison houses, and the like.

In block 515, routine 500 selects an action message to encourage the remote occupant taking the survey to improve the energy-efficiency score of the subject house. In various embodiments, an action message is selected based at least in part on the energy-efficiency score of the subject house and/or the relationship between subject house and comparison energy-use data. For example, an action message may include information such as the following:
Your energy-efficiency score is 28 points lower than efficient homes in Redmond, Wash.

In various embodiments, the action message is selected to encourage a remote occupant completing the survey to improve the energy-efficiency score of the subject house. In some embodiments, the action message is selected based on behavioral economics. For example, the action message may provide social (e.g., “You are contributing to global warming.”), psychological and/or economic incentives for a homeowner to take action (e.g., “Your energy-efficiency score is less than your neighbors' homes.”, “Your estimated 3 year savings is $4,011 if you improve your energy efficiency.”, or the like).

For another example, the action message may present a remote occupant with concrete, manageable, and customized action items or projects that a remote occupant can easily take on (e.g., “Improve attic insulation to modern standards. This will add 13 points to your energy-efficiency score.”).

In block 520, routine 500 provides a comparison UI to present the energy-efficiency score of the subject house in relation to the comparison energy-use data and/or the action message. In various embodiments, the comparison UI is provided to encourage a remote occupant to improve the energy efficiency of the subject house. For example, comparison UI may include a graphical depiction of the energy-efficiency score, its relationship with comparison energy-use data, potential energy savings (e.g., in utility bills) if the remote occupants were to make improvements, and the like, to facilitate decision-making. In various embodiments, potential energy savings may be calculated based at least in part on energy cost, applicable energy rebate, tax credit, and other incentive programs offered by governments and/or service providers, and the like. For another example, the comparison UI may have a simple design (e.g., one page, easy-to-understand message, and the like) to make it easy for a remote occupant to take action. In block 520, routine 500 provides the comparison UI, such as described above, to energy consumer device 115 to be rendered in a web browser. Routine 500 ends in block 599.

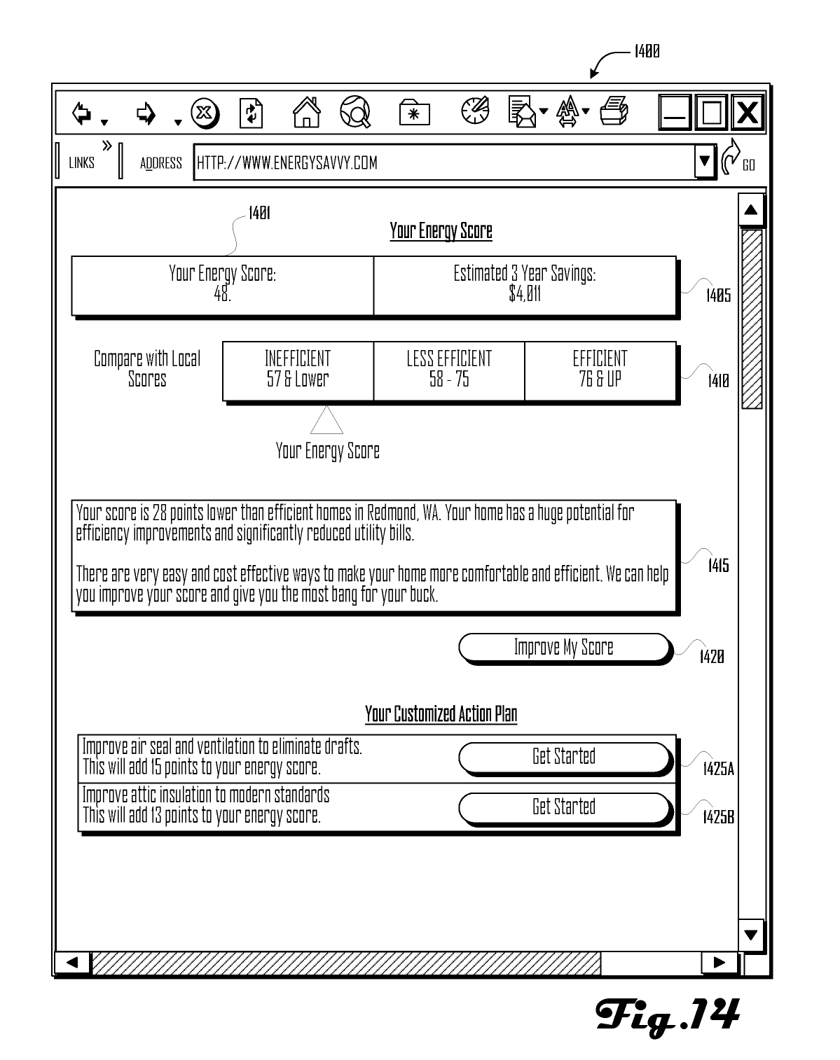

For example, FIG. 14 illustrates an exemplary comparison UI 1400, as may be presented to a remote occupant using an energy consumer device 115, in accordance with one embodiment. In the illustrated embodiment, comparison UI 1400 includes the energy-efficiency score of the subject house 1401 and potential 3-year energy savings 1405 (e.g., in utility bills) associated with energy efficiency improvements.

Comparison UI 1400 also includes a ranking 1410 of the energy-efficiency score of the subject house in relation to energy-efficiency scores of other comparison houses and an action message 1415 encouraging a remote occupant to take action. Comparison UI 1400 further includes an “Improve my score” button 1420 which would take a remote occupant to another UI with, e.g., a list of available energy contractors/vendors within the subject house's zip code.

In addition, comparison UI 1400 includes a “Your Customized Action Plan” section where an action message presents the remote occupant with options 1425A-B to improve energy efficiency for specific aspects of the subject house, e.g., air sealing and ventilation, attic insulation, and the like. Each option may be associated with an improved-home energy-efficiency score (discussed below). When a remote occupant selects a particular energy efficiency option (e.g., by clicking on the “Get Started” button), the remote occupant may be taken to another UI with, e.g., a list of available energy contractors/vendors for that particular option.

FIG. 6 illustrates a subroutine for obtaining an energy-efficiency score for a subject house, in accordance with one embodiment. In block 605, subroutine 600 obtains a subject-house energy-use profile associated with a subject house (e.g., from database 120).

In block 610, subroutine 600 determines the model inputs associated with an energy-use software model (e.g., see item 260 of FIG. 2 or block 305 of FIG. 3). In various embodiments, each model input maybe associated with one or more predetermined possible input values.

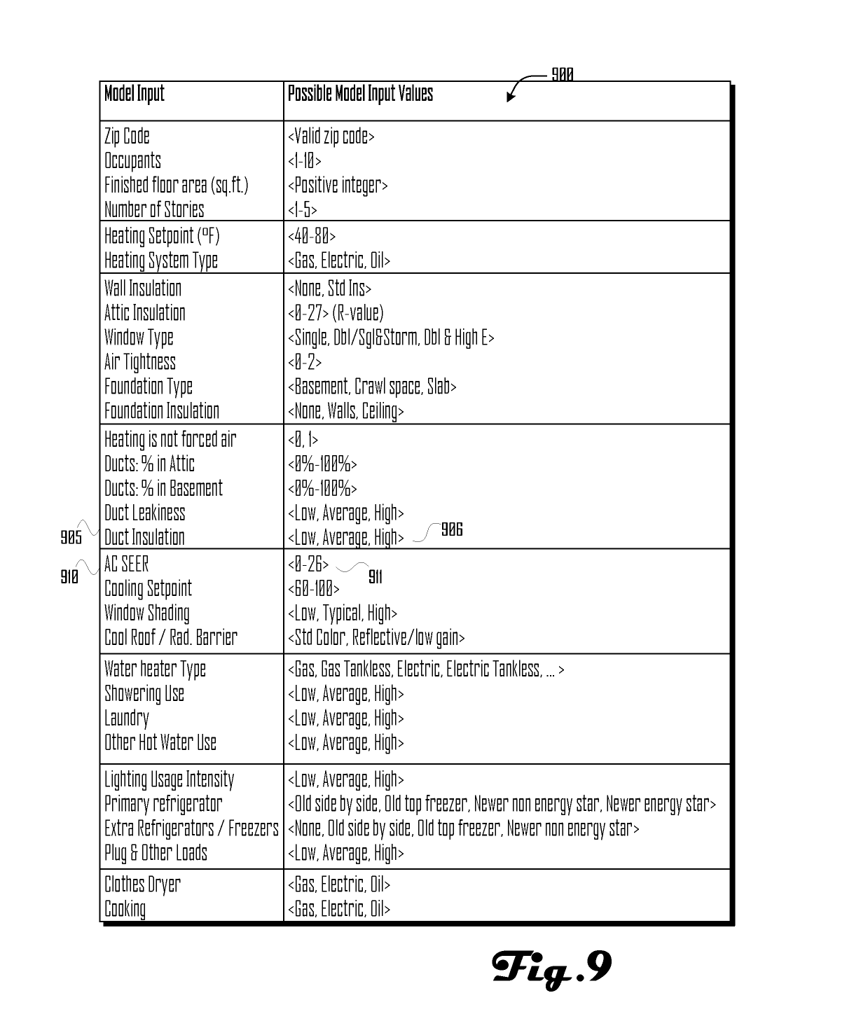

For example, FIG. 9 illustrates exemplary model inputs and their respective predetermined possible input values, in accordance with one embodiment. For example, the model input “Duct Insulation” 905 has three possible input values 906 “Low,” “Average,” and “High”. For another example, the model input “AC seer” 910 has possible input values 911 of predetermined integers between 0 and 26.

Referring again to FIG. 6, beginning in opening loop block 615, subroutine 600 processes each model input associated with the energy-use software model in turn. In decision block 620, subroutine 600 determines whether the current model input is “associated” with one or more survey responses from the subject-house energy-use profile. In various embodiments, a survey response is associated with a model input if a model input value for the model input can be derived, at least in part, from the survey response.

If it is determined that the current model input is not associated with any survey response from the subject-house energy-use profile, then in block 640 subroutine 600 obtains a constant input value and in block 645, subroutine 600 populates the model input with the obtained constant input value. In various embodiments, a constant input value is selected from one or more predetermined possible input values corresponding to the current model input and is used to reduce the quantity of survey responses that need to be collected to populate the model inputs of an energy-use software model (e.g., item 260 of FIG. 2). Table 1 shows exemplary model inputs whose input values may be held constant, in accordance with one embodiment. In the exemplary embodiment, the model input to which constant input value corresponds is selected from an input group consisting of inputs related to duct leakiness, laundry water use, hot water use other than laundry and shower, and electrical load other than lighting. In the exemplary embodiment, constant input values may be selected from a constant-value group including “Average” and “Low.”

TABLE 1
Exemplary model inputs with constant input values, in accordance
with one embodiment.

| Model inputs related to: | Constant input value |
|---|---|
| Duct leakiness | Average |
| Laundry water use | Low |
| Hot water use other than laundry and shower | Average |
| Electrical load other than lighting | Average |

In some embodiments, subroutine 600 may automatically obtain energy-usage data associated with the subject house from an energy-provider device 110. For example, such energy-use data may include cost of energy, utility data for the subject house or houses in the same zip code, and the like. In some embodiments, subroutine 600 may further obtain constant input values corresponding to model inputs by selecting among a range of predetermined values based at least in part on the automatically-obtained energy-usage data. For example, subroutine 600 may set the constant input value corresponding to a model input related to “Electrical load other than lighting” to “Average” if automatically-obtained energy-usage data indicates that electrical usage other than lighting associated with the subject house and/or similar houses is about average.

Otherwise, if it is determined, in decision block 620, that the current model input is associated with one or more survey responses from the subject-house energy-use profile, then in decision block 625, subroutine 600 determines whether the one or more survey responses map directly to the current model input. In various embodiments, a survey response maps directly to a model input when there is a one-to-one correspondence between possible survey responses and possible model input values.

For example, Table 2 illustrates exemplary model inputs whose input values are directly mapped to survey responses, in accordance with one embodiment. For example, in one embodiment, a survey response to a question about the finished floor area of a house is mapped directly to a corresponding numeric value for a model input related to “Finished floor area.” For another example, one of each of the three possible survey responses selected for the question regarding the foundation type of a house is mapped directly to corresponding model input value for a model input related to “Foundation type.”

TABLE 2
Exemplary directly-mapped model input values, in
accordance with one embodiment.

| Model Input related to: | Survey Response | Model input value |
|---|---|---|
| Zip code | <valid zip code> | <valid zip code> |
| Finished floor area | <positive integer> | <positive integer> |
| Stories | <1-5> | <1-5> |
| Occupants | <1-10> | <1-10> |
| Heating setpoint | <40-80> | <40-80> |
| Cooling setpoint | <60-100> | <60-100> |
| Foundation type | Basement | Basement |
| | Crawl space | Crawl space |
| | Slab | Slab |
| Window shading | Minimal shading | Low |
| | Typical | Typical |
| | Highly shaded | High |
| Shower usage | Short showers or low | Low |
| | flow shower heads | |
| | We're probably | Average |
| | about average | |
| | Long hot showers | High |
| Light usage | Low amount or | Low |
| | mostly CFL bulbs | |
| | Probably about | Average |
| | average | |
| | Lots of lights and | High |
| | no CFL bulbs | |
| Primary Refrigerator | From before 1993 and | Old side by side - pre 93 |
| | is side by side | |
| | From before 1993 and | Old top freezer - pre 93 |
| | has a freezer | |
| | on the top | |
| | From after 1993, but | Newer Non Energy Star |
| | isn't energy star | |
| | From after 1993, and | Newer Energy Star |
| | is energy star | |

If it is determined in decision block 625 that there is a direct mapping between survey responses and model input values for the current model input, then in block 650 subroutine 600 obtains the model input value corresponding to the survey response associated with the model input in block 650 and populates the model input with the corresponding input value in block 655.

Otherwise, if it is determined in decision block 625 that there is no direct mapping between survey responses and model input values for the current model input, then in block 630 subroutine 600 infers an input value based on one or more survey responses. In various embodiments, a model input value may be inferred to facilitate the completion of the survey. For example, a model input value may be inferred when a remote occupant is unsure about an input value and/or to reduce the number of questions that need to be asked in the survey.

In some embodiments, a model input value may be inferred based on a survey response to a survey question that is directly related to the model input. For example, Table 3 illustrates exemplary model inputs whose values may be inferred from directly-related survey responses, in accordance with one embodiment. For example, the numeric input value for model input related to “AC seer” may be inferred from the survey response to the question of “What best describes your home's primary air conditioner?” For another example, the numeric input value for model input related to “Attic insulation” may be inferred from the survey response to the question of “How much attic insulation do you have?”

TABLE 3
Exemplary inferred model input values, in accordance
with one embodiment.

| Model Input related to: | Survey Response | Inferred input value |
|---|---|---|
| AC seer | More than 20 years old | 9 |
| | 4 through 20 years old | 11 |
| | Less than 4 years old | 13 |
| | No AC | 0 |
| Attic insulation | No insulation | 5 |
| | Some insulation | 9 |
| | Thick insulation | 19 |

In various embodiments, inferred input values represent a subset of all possible model input values. For example, the inferred input values {9, 11, 13, 0} for model input related to “AC seer” may represent a subset of possible model input values {0-26} associated with the model input.

In various embodiments, inferred values may be used to facilitate a remote occupant selecting an appropriate response to a survey question. For example, an ordinary homeowner may not understand what an “AC seer rating” is for the house's AC. However, a homeowner is more likely to know how old an air conditioner is. Therefore, an inference between the age and the seer rating of an air conditioner, such as illustrated in Table 3, allows a survey to ask a relatively simple question (e.g., age of an AC) for a relatively abstruse model input (e.g., AC seer rating).

In other embodiments, a model input value may be inferred based on a survey response to a survey question that is indirectly related to the model input. Indirectly-related survey responses may include the vintage of a house, the zip code of a house, and the like. In some embodiments, subroutine 400 may select, based at least in part on the indirectly-related survey responses (e.g., vintage of a subject house), an input value for one of model inputs from a group of varying input values.

Table 4 illustrates exemplary inferred model input values based on indirectly-related survey responses, in accordance with one embodiment. For example, the wall insulation of a house may be inferred from the vintage of the house. In this example, if the house vintage indicates that the house is built after 1980, then the model input value for model input related to “Wall insulation” is inferred to be “Standard Insulation.” For another example, if the foundation type of the house is not “Crawl space” or “Basement,” then the model input value for a model input related to “% Duct in attic” may be inferred to be “75%.”

TABLE 4
Exemplary inferred model input values based on indirectly-related
survey responses, in accordance with one embodiment.

| Model Input | | |
|---|---|---|
| related to: | Survey Response | Inferred input value |
| Wall insulation | <Year built> greater than 1980 | Standard Insulation |
| % Duct in attic | <Foundation type> is not | 75% |
| | “Crawl space” or “Basement” | |

In some embodiments, a model input value may be inferred based on multiple (directly and/or indirectly related) survey responses. For example, an inferred value may be selected, based at least in part on the vintage of a subject house, from a group of varying input values. Table 5 illustrates, in an exemplary embodiment, how the model input value for model input related to “Air tightness” may be inferred from a group of varying input values based on both the house vintage (indicated by the leftmost column of Table 5) and response to the survey question of “How drafty does your home feel?” (indicated by the top row of Table 5).

TABLE 5
Exemplary inferred model input value for a model input related to
“Air tightness” based on multiple survey responses,
in accordance with one embodiment.

| | | “Somewhat | | |
|---|---|---|---|---|
| | “Very drafty” | drafty” | “Not drafty at all” | “Not sure” |
| Pre-1945 | 1.45 | 1.30 | 1.15 | 1.3 |
| 1945-79 | 1.30 | 1.15 | 0.85 | 1.15 |
| 1980+ | 1.15 | 1.00 | 0.75 | 1 |

In other embodiments, multiple model input values may be inferred from a single response to a survey question. For example, Table 6 illustrates, in an exemplary embodiment, how exemplary model input values for model inputs related to “Duct leakiness” and “Duct insulation” may be inferred from the response to the question of “What type of ducts are in your home.”

TABLE 6
Exemplary multiple inferred model inputs based on one response,
in accordance with one embodiment.

| Model Input related to | Model Input related to | |
|---|---|---|
| “Duct leakiness” | “Duct insulation” | Survey Response |
| Average | Average | Flexible ducts |
| Average | Average | Hard duct with insulation |
| None | Average | Hard duct without |
| | | insulation |

In some embodiments, multiple model input values may be inferred based on multiple survey responses questions. For example, Table 7 illustrates, in an exemplary embodiment, how model input values for model inputs related to “% Duct in attic” and “% Duct in crawl space” may be inferred from two survey responses, foundation type and whether there are ducts in attic (which, in one embodiment, may be inferred from a response to a question asking whether there are ceiling vents in the house). This example also illustrates that multiple model input values maybe inferred from one survey response (e.g., when foundation type is “Crawl space” or “Slab”), thus reducing the number of questions that need to be asked.

TABLE 7
Exemplary inferred model inputs related to “% Duct in attic” and “%
Duct in crawl space”, in accordance with one embodiment.

| | Survey | | |
|---|---|---|---|
| | response | Survey | |
| Model Input | <Foundation | response - | |
| related to: | type> | <Ducts in attic> | Inferred input values |
| <% Duct in attic, | Basement | Yes | <25%, 50%> |
| % Duct in | | No | <0%, 75%> |
| basement/ | | Not sure | <0%, 75%> |
| crawl space> | Slab | <question not | <75%, 0%> |
| | | asked> | |
| | Crawl space | <question not | <0, 75%> |
| | | asked> | |

In some embodiments, a model input value may be inferred from data that is not directly obtained from the remote occupant completing the survey. For example, Table 8 illustrates how the model input value for “Attic insulation” may be inferred from the house vintage and Heat Degree Day (HDD) value for the house, in accordance with one embodiment. An HDD is a measurement of energy requirement to heat a given building. Generally, the heating requirements for a given structure at a specific location are considered to be proportional to the number of HDD at that location. HDDs are typically defined relative to a base outside temperature above which heating is not required. One popular approximation method of HDD is to take the average temperature on any given day, and subtract it from the base temperature. If the value is less than or equal to zero, that day has zero HDD. But if the value is positive, that number represents the number of HDD on that day. For illustrative purpose, the HDD in Table 8 represent the annual HDD for a given house. In this embodiment, when a remote occupant is unsure about the type of attic insulation in the house, a numeric insulation R-value may be inferred from a combination of the vintage of the house and the HDD of the house as shown in Table 8.

TABLE 8
Inferred model input values for a model input related to
“Attic insulation” based on house vintage and HDD,
in accordance with one embodiment.

| | HDD < 3500 | 3501 < HDD < 6000 | HDD > 6000 |
|---|---|---|---|
| Pre-1960 | 9 | 9 | 13 |
| 1961-1979 | 9 | 13 | 19 |
| 1980+ | 13 | 19 | 27 |

As discussed above, in various embodiments, model input values may be inferred from data (e.g., HDD value) that is not directly obtained from the remote occupant. In some embodiments, such data may be obtained from or based on data from external sources such as energy providers, government agencies (e.g., Department of Energy, Census Bureau, and the like), climate data providers, and the like. In other embodiments, such data may be calculated based data obtained from a remote occupant (e.g., zip code, vintage of a house, heating setpoint, and the like).

In various embodiments, inferred model input values may be used to reduce the quantity of survey responses that need to be collected to populate a given model input (see discussion of Table 4, Table 6, and Table 7, above) and/or to facilitate the remote occupant entering the proper response (see discussion of Table 3, Table 5, and Table 8, above).

Still referring to FIG. 6, in block 635, subroutine 600 populates the current model input with an inferred model input value. As discussed above, in various embodiments, one or more model inputs may be populated by model input values inferred from one or more survey responses and/or data not directly obtained from the remote occupant.

In closing loop block 660, subroutine 600 iterates back to opening loop block 615 to process the next model input, if any.

Once all model inputs have been processed, in block 665, subroutine 600 obtains an energy-efficiency score based on output from the energy-use software model with populated model inputs. In various embodiments, an energy-use software model is populated with model inputs as described above. Further, in some embodiments, an energy-use software model may also be populated with additional data obtained from sources other than remote occupant. For example, an energy-use software model may be populated with climate data for the subject house's zip code location from a weather service provider, energy-usage data (e.g., utility cost, usage statistics, and the like) from an energy provider, and the like.

In various embodiments, an energy-efficiency “score” may be derived at least in part from an energy-usage estimate provided by an energy-use software model. For example, in some embodiments, an energy-usage estimate may be expressed in units of energy consumed, such as in million British thermal unit (“MBtu”). In some other embodiments, an energy-usage estimate may be expressed as the amount of money spent on energy, such as in U.S. dollar. In yet other embodiments, an energy-use software model may provide an energy-efficiency score instead of or in addition to an energy-usage estimate.

As described above, an energy-efficiency score indicates the energy efficiency of a subject house. In some embodiments, an energy-efficiency score may be computed by comparing the energy-usage estimate of the subject house with the energy-usage estimate of an idealized house (see discussion of FIG. 7 below). For example, in one embodiment, if the energy-usage estimate of the subject house is 200 Mbtu and if the energy-usage estimate of an idealized house is 100 Mbtu, then the energy-efficiency score of the subject house may be 50 (while the maximum score may be 100). In other embodiments, an energy-efficiency score may be computed by comparing the energy-usage estimate of a subject house to one or more predetermined threshold values. For example, in one embodiment, if a subject house has an estimated annual energy-usage that falls between 202-204 Mbtu, the house is given a score of 70; whereas if the energy-usage is betwwen 200-202 Mbtu, the house is given a score of 71. In various embodiments, the above-mentioned predetermined threshold values for determining an energy-efficiency score may be determined by the location of the house, local climate data, energy-usage data of similar houses, population statistics, and the like.

In various embodiments, comparison energy-use data may be used to generate an efficiency score a subject house, an action message for the remote occupant of the survey, and the like. As described above, in various embodiments, comparison energy-use data may include the energy-efficiency score of an actual or hypothetical comparison house, energy-efficiency scores of a collection of comparison houses similar to the subject house, and the like.

In ending block 699, subroutine 600 returns the energy-efficiency score.

FIG. 7 illustrates a subroutine 700 for obtaining comparison energy-use data, in accordance with one embodiment. Such comparison energy-use data may be used, for example, to generate a customized action plan for a remote occupant to improve the energy efficiency of certain characteristics of the house (see items 1425A-B of FIG. 14, discussed above).

In block 705, subroutine 700 selects one or more predetermined “improvable” house characteristics from the house characteristics associated with a subject house. Typically, an “improvable” house characteristic is one that a homeowner is more likely to modify to improve the energy efficiency of the subject house. Examples of improvable house characteristics may include insulation, HVAC, windows, appliances, energy usage, and the like. In contrast, a homeowner may be unlikely to modify a “non-improvable” house characteristic to improve the energy efficiency of the house. Examples of non-improvable house characteristics may include the location of the house, the number of stories, the number of occupants, foundation type, and the like. For example, FIG. 10 illustrates a survey UI presenting questions corresponding to non-improvable house characteristics, in accordance with one embodiment.

In some embodiments, subroutine 700 identifies a home-improvement package offered by a vendor and selects one or more improvable characteristics that correspond to the home-improvement package. In various embodiments, a home-improvement package may be designed to improve some or all aspects of home energy use, including insulation, HVAC, weatherization, appliances, and the like. In various embodiments, vendors of home-improvement packages may include energy providers, contractors, manufacturers, retailers, and the like. In some embodiments, a vendor may be partnered with the energy audit service. For example, if a partner contractor provides HVAC services, subroutine 700 may identify improvable characteristics corresponding to HVAC of the subject house such as water heating type, AC seer rating, and the like. For another example, if a partner energy provider provides natural gas, subroutine 700 may identify improvable characteristics corresponding to the type of energy used for the house such as for heating, water heater, clothes dryer, cooking, and the like.

In block 710, subroutine 700 selects one or more non-improvable survey responses, from the subject-house energy-use profile, corresponding to one or more non-improvable house characteristics (e.g., vintage and location of the house, number of stories, number of occupants, foundation type, and the like).

In block 715, subroutine 700 obtains one or more idealized responses corresponding to the one or more improvable characteristics selected above. In various embodiments, an idealized response represents what the response would have been for a more energy efficient house, or an “idealized house”. As used herein, an “idealized house” refers to a house with improved energy efficiency for some or all improvable house characteristics of the subject house. For example, if the subject house currently uses an electric water heater but it is determined (based on the cost of electricity and gas, for example) that a gas heater would be more energy efficient, an idealized response to the “water heater type” house characteristic would be “gas.”

In block 720, subroutine 700 generates an “improved-home energy-use profile” for the subject house. In various embodiments, an “improved-home energy-use profile” is generated according to the one or more non-improvable responses of the subject house and the one or more idealized responses corresponding to the selected improvable characteristics of an idealized house, discussed above. For example, an improved-home may have the same vintage, number of stories, number of occupants, and foundation type, but may have better duct insulation and/or air sealing than the subject house.

In block 725, subroutine 700 obtains an energy-efficiency score for the improved-home energy-use profile. In various embodiments, block 725 is performed via an energy-use software model such as item 260 of FIG. 2 (see FIG. 6, discussed above).

In ending block 799, subroutine 700 returns comparison energy-use data including the energy-efficiency score for the improved-home energy-use profile. In some embodiments, subroutine 700 may generate one or more improved-home energy-use profiles, and hence energy-efficiency scores, corresponding to one or more home-improvement packages offered by partner vendors. In some embodiments, such improved-home energy-use profiles and energy-efficiency scores may be used to generate a customized action plan for a remote occupant (see e.g., items 1425A-B of FIG. 14, discussed above).

FIG. 8 illustrates a subroutine 800 for obtaining comparison energy-use data, in accordance with one embodiment. Such comparison energy-use data may be used, for example, to generate an action message to encourage a remote occupant to improve efficiency score a subject house (see e.g., items 1410 and 1415 of FIG. 14, discussed above).

In block 805, subroutine 800 selects a collection of comparison houses similar to the subject house. In various embodiments, selected comparison houses may be actual or hypothetical. In some embodiments, selected comparison houses may be similar to the subject house with respect to one or more of size, location, and vintage. For example, comparison houses may include actual houses with the same zip code as the subject house or houses with similar vintage and/or size as the comparison house. For another example, comparison houses may include idealized houses (see FIG. 7, discussed above).

Beginning in opening loop block 810, subroutine 800 processes each comparison house in turn.

In block 815, subroutine 800 obtains an energy-efficiency score of the current comparison house. In various embodiments, an energy profile is generated for the comparison house and an energy-efficiency score is obtained by feeding the comparison-house energy profile into an energy-use software model (e.g., item 260 of FIG. 2), as described in the discussion of FIG. 6 above.

In closing loop block 820, subroutine 800 iterates back to opening loop block 810 to process the next comparison house, if any.

In ending block 899, subroutine 800 returns comparison energy-use data including the energy-efficiency scores for the comparison houses. As discussed in relation to block 510 of FIG. 5, energy-efficiency scores may be used to rank the subject house among comparison houses.

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

1. A computer-implemented method for profiling the energy use of a subject house, the method comprising:
obtaining, by the computer, a plurality of survey questions related to a plurality of house characteristics, each of said questions being associated with a plurality of pre-determined answer options;
providing, by the computer via a computer network, a survey user interface (“UI”) for posing and collecting responses to said plurality of survey questions, including for each of said plurality of survey questions, providing a question-specific plurality of house-feature images for presentation in said survey UI to facilitate said remote occupant selecting an appropriate answer option for the current question, each house-feature image depicting a representative house feature corresponding to a pre-determined answer option;
collecting, by the computer via said survey UI, a plurality of survey responses from a remote occupant of the subject house, each survey response indicating a selected answer option corresponding to one of said plurality of survey questions; and
storing, by the computer, said plurality of survey responses into a subject-home energy-use profile associated with the subject house.

2. The method of claim 1, further comprising obtaining an energy-use software model having a plurality of model inputs corresponding respectively to said plurality of house characteristics.

3. The method of claim 2, further comprising determining, based at least in part on said survey responses of said subject-home energy-use profile, a plurality of input values to respectively populate said model inputs of said energy-use software model.

4. The method of claim 3, wherein determining said plurality of input values comprises:
obtaining a plurality of predetermined possible input values corresponding to one of said model inputs; and
selecting one of said predetermined possible input values based on at least one of said survey responses.

5. The method of claim 3, wherein determining said plurality of input values comprises obtaining a constant input value corresponding to one of said model inputs, but not corresponding to any of said plurality of survey responses, said constant input value being utilized to reduce the quantity of survey responses that need to be collected to populate said model inputs of said energy-use software model.

6. The method of claim 5, wherein the model input to which said constant input value corresponds is selected from an input group consisting of inputs related to duct leakiness, laundry water use, hot water use other than laundry and shower, and electrical load other than lighting.

7. The method of claim 6, wherein obtaining said constant input value corresponding to one of said model inputs comprises selecting said constant input value from a constant-value group consisting of “Average” and “Low”.

8. The method of claim 5, wherein obtaining said constant input value corresponding to one of said model inputs comprises automatically obtaining energy-usage data associated with the subject house from an energy-provider device.

9. The method of claim 8, wherein obtaining said constant input value further comprises selecting among a range of predetermined values based at least in part on said automatically-obtained energy-usage data.

10. The method of claim 3, wherein determining said plurality of input values comprises obtaining a survey response indicating a vintage of the subject house, and selecting, based at least in part on said vintage of the subject house, an input value for one of said model inputs from a group of varying input values.

11. The method of claim 3, wherein collecting said plurality of survey responses comprises:
obtaining a survey response to one of said plurality of survey questions;
determining, based at least in part on said obtained survey response, not to ask another of said plurality of survey questions.

12. The method of claim 11, wherein said obtained survey response indicates that the subject house lacks a basement or crawlspace, and wherein the unasked survey question relates to basement or crawlspace air ducts.

13. The method of claim 11, further comprising obtaining an assumed input value corresponding to one of said model inputs and to the unasked survey question, said assumed input value being utilized to reduce the quantity of survey responses that need to be collected to populate said model inputs of said energy-use software model.

14. The method of claim 13, wherein said obtained survey response indicates that the subject house lacks a basement or crawlspace, and wherein said assumed input value assumes that a majority of air ducts of the subject house are in an attic of the subject house.

15. The method of claim 1, wherein for at least one of said plurality of survey questions, said survey UI simultaneously presents each of said question-specific plurality of house-feature images in said survey UI to facilitate said remote occupant selecting an appropriate answer option for the current question.

16. The method of claim 1, wherein said survey UI presents no answer-option-selection controls that require alphanumeric data entry.

17. The method of claim 3, further comprising using said populated model inputs of said energy-use software model to determine an energy-efficiency score for the subject house.

18. The method of claim 17, further comprising:
obtaining a comparison energy-efficiency score for an actual or hypothetical comparison house; and
providing a comparison user interface (“UI”) for presenting said energy-efficiency score for the subject house in relation to said comparison energy-efficiency score for an actual or hypothetical comparison house.

19. The method of claim 18, wherein obtaining said comparison energy-efficiency score for an actual or hypothetical comparison house comprises:
selecting a subset of one or more improvable characteristics from said plurality of house characteristics;
from said plurality of survey responses of said subject-home energy-use profile, selecting a plurality of non-improvable responses that are associated with non-improvable characteristics of the subject house;
obtaining one or more idealized responses corresponding to said one or more improvable characteristics of an idealized house; and
generating an improved-home energy-use profile for the subject house according to said plurality of non-improvable responses associated with non-improvable characteristics of the subject house and to said one or more idealized responses corresponding to said improvable characteristics of an idealized house.

20. The method of claim 18, further comprising selecting and presenting an action message in said comparison UI to encourage said remote occupant to improve said energy-efficiency score for the subject house based at least in part on said energy-efficiency score.

21. The method of claim 18, wherein obtaining said comparison energy-efficiency score comprises selecting a plurality of comparison houses that are similar to the subject house with respect to at least one of size, location, and vintage, and that are respectively associated with a plurality of comparison-house energy-efficiency scores.

22. The method of claim 21, wherein providing said comparison UI for presenting said energy-efficiency score for the subject house in relation to said comparison energy-efficiency score comprises ranking the subject house and said selected plurality of comparison houses according to their respective energy-efficiency scores.

23. The method of claim 22, further comprising selecting and presenting an action message in said comparison UI to encourage said remote occupant to improve said energy-efficiency score for the subject house based at least in part on said ranking of the subject house and said selected plurality of comparison houses.

24. The method of claim 18, wherein providing said comparison UI comprises:
determining a mathematical relationship between said energy-efficiency score for the subject house in relation to said comparison energy-efficiency score for an actual or hypothetical comparison house; and
selecting an action message to encourage said remote occupant to improve said energy-efficiency score for the subject house based at least in part on said mathematical relationship.

25. The method of claim 18, wherein selecting said subset of one or more improvable characteristics from said plurality of house characteristics comprises:
identifying a home-improvement package offered to said remote occupant by a partner vendor; and
selecting one or more improvable characteristics that correspond to said home-improvement package.

26. A non-transient computer-readable storage medium having stored thereon instructions that, when executed by a processor, configure the processor to perform the method of claim 1.

27. A computing apparatus comprising a processor and a memory storing instructions that, when executed by the processor, configure the apparatus to perform the method of claim 1.
